(19) United States
(12) Patent Application Publication
(10) Pub. No.: US 2019/0263046 A1
(43) Pub. Date: Aug. 29, 2019

(54) THERMOFORMABLE MASKING FILM AND METHOD OF USING THE SAME

(71) Applicant: SABIC Global Technologies B.V., Bergen op Zoom (NL)

(72) Inventors: Rein Mollerus Faber, Bergen op Zoom (NL); Petrus Jacobus Akkermans, Bergen op Zoom (NL); Hendrikus Petrus Cornelis van Heerbeek, Bergen op Zoom (NL); Duygu Deniz Günbas, Bergen op Zoom (NL)

(21) Appl. No.: 16/091,183

(22) PCT Filed: Apr. 6, 2017
(86) PCT No.: PCT/IB2017/051994

§ 371 Date: Oct. 4, 2018

Related U.S. Application Data
(60) Provisional application No. 62/319,906, filed on Apr. 8, 2016.

(51) Int. Cl. B29C 51/02; B29C 48/00; B29C 48/08; B29C 48/21; B29C 51/14; B32B 27/08; B32B 27/34; B32B 27/36; B32B 7/12; B32B 27/32; B32B 27/30

(52) U.S. Cl. CPC B29C 51/02; B29K 2077/00; B29C 48/08; B29C 48/21; B29C 51/14; B32B 27/08; B32B 27/34; B32B 27/365; B32B 7/12; B32B 27/32; B32B 27/306; B32B 2307/738; B32B 2307/732; B32B 2605/10; B32B 2605/08; B29C 48/0017

(57) ABSTRACT

A thermoplastic sheet includes a thermoplastic substrate; and a masking film applied to a surface of the thermoplastic substrate; wherein the masking film comprises a polyamide, a polyester, or a combination comprising at least one of the foregoing; wherein after thermoforming the thermoplastic sheet, the thermoplastic sheet and the masking film are free from discolorations. A method of thermoforming an article includes extruding a thermoplastic sheet; applying a masking film to a surface of the thermoplastic sheet, wherein the masking film comprises a polyamide, a polyester, or a combination comprising at least one of the foregoing; shaping the thermoplastic sheet to form the article, wherein the masking film remains in contact with the surface of the thermoplastic sheet during shaping; and after cooling the article, removing the masking film from a surface of the article.

### BACKGROUND

Dust fibers attracted to thermoplastic sheeting during forming processes can leave behind undesirable imprints (i.e., discolorations) in a surface of the final, formed part. It can be difficult or even nearly impossible to control dust formation in a production environment without requiring large investments in items such as a cleanroom environment in which to form the thermoplastic sheeting, air-filtration in the forming environment, or dedicated working spaces to avoid outside contamination. Dust fibers from the production environment can settle down or can be attached to the thermoplastic sheet during part production. The dust fibers, which manifest as discolorations, are not visible on the flat sheet, but appear when the sheet is heated. The dust fibers can be of a fibrous shape and only found in the surface of the thermoplastic sheet. The intensity and number of dust fibers increases at higher temperatures, longer exposure duration, and higher pressure.

Thus, there is a need for thermoplastic sheets devoid of these discolorations.

### SUMMARY

Disclosed, in various embodiments, are thermoplastic sheets and methods of making thereof.

A thermoplastic sheet, comprises: a thermoplastic substrate; and a masking film applied to a surface of the thermoplastic substrate; wherein the masking film comprises a polyamide, a polyester, or a combination comprising at least one of the foregoing; wherein after thermoforming the thermoplastic sheet, the thermoplastic sheet and the masking film are free from discolorations.

A method of thermoforming an article, comprises: extruding a thermoplastic sheet; applying a masking film to a surface of the thermoplastic sheet, wherein the masking film comprises a polyamide, a polyester, or a combination comprising at least one of the foregoing; shaping the thermoplastic sheet to form the article, wherein the masking film remains in contact with the surface of the thermoplastic sheet during shaping; and after cooling the article, removing the masking film from a surface of the article.

These and other features and characteristics are more particularly described below.

### BRIEF DESCRIPTION OF THE DRAWINGS

The following is a brief description of the drawings wherein like elements are numbered alike and which are presented for the purposes of illustrating the exemplary embodiments disclosed herein and not for the purposes of limiting the same.

FIG. 1 is a cross-sectional view of a thermoplastic sheet as disclosed herein.

FIG. 2 is a cross-sectional view of another thermoplastic sheet as disclosed herein.

### DETAILED DESCRIPTION

Disclosed herein are thermoplastic sheets that can solve the problems associated with dust contamination on a surface of the thermoplastic sheet during heating and/or thermal processing (e.g., thermoforming, injection molding, etc.), which can cause rejection of the thermoplastic sheets and/or articles made therefrom. The thermoplastic sheet can include a thermoplastic substrate with a masking film applied to a surface of the thermoplastic substrate. The masking film can comprise a polyamide, a polyester, or a combination comprising at least one of the foregoing. After thermoforming the thermoplastic sheet, thermoplastic sheet and the masking film can be free from discolorations. “Free from” as used herein refers to zero discolorations present on the thermoplastic sheet due to dust contamination during heating and/or thermal processing. The dust contamination can include colored spots (e.g., blue spots) as a result of fibers present in the dust. The colored spots can be more pronounced on lighter colors. Without wishing to be limited by theory, it is believed that dark spots (e.g., blue spots) can be caused by diffusion of the dye from textile fibers (e.g., blue jeans) into the thermoplastic part. Analysis from fibers remaining on the formed part after forming (e.g., by thermoforming or injection molding) demonstrated that the fibers were mostly cellulose based (i.e., textile, blue jeans). Color intensity of the discolorations can be highest in the center and can become weaker and more diffuse when moving away from the center of the fibrous shape. It is to be understood that thermoplastic sheet, thermoplastic sheeting, substrate, and substrate sheet are used interchangeably herein.

Since it can be difficult and/or expensive to control dust in a production environment without large capital expenditures for a cleanroom environment or air filtration, it can be more cost efficient and productive to protect a thermoplastic sheet with a masking agent or film prior to processing in order to reduce or completely eliminate the formation of dust particulates on a surface of the thermoplastic sheet. The masking film can be applied to a surface of the thermoplastic sheet after formation of the thermoplastic sheet. The masking film can be adhered to the thermoplastic sheet with an adhesive disposed between the surface of the thermoplastic sheet and the masking film. The adhesive can be attached to the masking film before contacting the thermoplastic sheet. For example, the adhesive can be attached to the masking film after formation of the masking the film. For example, the masking film can be formed with an adhesive on a surface thereof. The masking film can remain adhered to the thermoplastic sheet through all subsequent production steps, including forming of the sheet into a shaped part or article. The masking film can be removed from the thermoplastic sheet after formation and cooling of the part or article. It was unexpectedly discovered that the use of a masking film comprising a polyamide, a polyester, or a combination comprising at least one of the foregoing can prevent the formation of discolorations on a surface of a thermoplastic sheet, even after forming the thermoplastic sheet by methods such as thermoforming or injection molding.

The masking film can comprise aliphatic polyamide, aromatic polyamide, or a combination comprising at least one of the foregoing. For example, the masking film can comprise polyamide-6 (PA6), polyamide 6,6 (PA6,6), polyamide-6,10 (PA6,10), polyamide 6,12 (PA6,12), polyamide-11 (PA11), polyamide-12 (PA12), polyamide 4,6 (PA4,6), polyamide 6T/XT (PA6T/XT), high performance polyamide (PPA) polyethylene terephthalate, or a combination comprising at least one of the foregoing. In an embodiment, the masking film can comprise polyamide-6. In an embodiment, the masking film can comprise polyamide-6,6. In an embodiment, the masking film can comprise a combination of polyamide-6 and polyamide-6,6. In an embodiment, the masking film can comprise polyethylene terephthalate. In an embodiment, the masking film can comprise a combination of polyamide-6 and polyethylene terephthalate.

The thermoplastic sheet can include a thermoplastic substrate (i.e., a thermoplastic substrate sheet). The thermoplastic sheet can be formed via extrusion. The thermoplastic sheet can be formed via co-extrusion, such that the thermoplastic sheet is a multilayer sheet. The thermoplastic sheet can be thermoformed to form an article. The article can be free from discolorations caused by dust particles. The article can be free from blue discolorations. The masking film can be applied to a surface of the thermoplastic substrate by methods including, but not limited to spraying, painting, coating, laminating, or a combination comprising at least one of the foregoing. The masking film can be coated with a rubber based glue, an acrylic adhesive, or a combination comprising at least one of the forgoing. The masking film can have a thickness of 15 to 100 micrometers, for example, 25 to 75 micrometers, for example, 50 micrometers.

Articles made from the thermoplastic sheets disclosed herein can include those for use in mass transportation applications such as automobiles, aircraft, or railway applications. For example, the articles can include tray tables, arm rests, etc. The thermoplastic sheets disclosed herein can be employed in a variety of aircraft and rail compartment interior applications, as well as interior applications for other modes of transportation, such as bus, train, subway, and the like. Exemplary aircraft interior components can include, without limitation, partition walls, cabinet walls, sidewall panels, ceiling panels, floor panels, equipment panels, light panels, window moldings, window slides, storage compartments, galley surfaces, equipment housings, seat housings, speaker housings, duct housing, storage housings, shelves, trays, and the like. The same applies to rail applications. It is generally noted that the overall size, shape, thickness, optical properties, electrical properties, and the like of the thermoplastic sheets disclosed herein can vary depending upon the desired application.

A method of thermoforming an article can include, extruding a thermoplastic sheet, applying a masking film to a surface of the thermoplastic sheet, shaping the thermoplastic sheet to form the article after heating the thermoplastic to a desired temperature for forming, and after cooling the formed article, removing the masking film from the surface of the article. The masking film can comprise polyamide, polyester, or a combination comprising at least one of the foregoing. The masking film can remain in contact with the surface of the thermoplastic sheet during shaping of the article. The shaping can occur at a wide variety of temperatures. For example, the shaping can occur at a temperature of 100° C. to 250° C., for example, 150° C. to 240° C., for example, 200° C. to 220° C.

Thermoforming is a manufacturing process where a plastic sheet is heated to a pliable forming temperature which is typically above the glass transition temperature of the plastic sheet, the sheet is then formed to a specific shape of a mold (of different geometry than the original plastic sheet) with vacuum assist, pressure assist or both, and trimmed to create a usable product. A thermoformable sheet means that the sheet can be thermoformed into the mold shape without mechanical failure of the sheet during the thermoforming process (e.g., without cracking, tearing, or other mechanical failure).

In vacuum forming processes, polymer material is heated until it becomes pliable, and then it is placed over a mold and drawn in by a vacuum until it takes on the desired shape. One type of vacuum forming technique is vacuum assisted plug and ring forming, which is capable of producing moderately complex parts. In plug and ring forming, polymer material in sheet form is stretched over a ring, and a plug (male mold) is pressed into the polymer material to draw it into shape. Another vacuum forming technique is drape vacuum forming, which is suitable for producing simple or only minimally complex parts. Parts such as windshields for vehicles can be draped formed from polycarbonate material having a thickness of about 3 millimeters (mm) in about 30 minutes or more. Forming using the drape vacuum forming technique involves stretching material in sheet form over a male mold before the material is cooled to a point where it does not flow anymore. To produce highly complex parts, techniques such as injection molding can be used.

The masking film can be applied to a surface of the thermoplastic sheet at room temperature. The masking film can be applied to a surface of the thermoplastic sheet at a temperature higher than room temperature. The masking film can be applied to a surface of the thermoplastic sheet at a temperature below the forming temperature of the masking film or the thermoplastic sheet. Stated another way, the masking film can be applied to the thermoplastic sheet at any temperature below that which the masking film loses its form and melts. The masking film can be applied to the surface of the thermoplastic sheet via methods such as including, but not limited to, spraying, painting, coating, laminating, or a combination comprising at least one of the foregoing. The article can be formed via any sheet molding process, such as, thermoforming or injection molding.

The masking film can be removed from the surface of the article at room temperature via scraping, peeling, or a combination comprising at least one of the foregoing.

Possible thermoplastic polymers that may be employed for the thermoplastic sheet include, but are not limited to, oligomers, polymers, ionomers, dendrimers, copolymers such as graft copolymers, block copolymers (e.g., star block copolymers, random copolymers, etc.) and combinations comprising at least one of the foregoing. Examples of such thermoplastic polymers include, but are not limited to, polycarbonates (e.g., blends of polycarbonate (such as, polycarbonate-polybutadiene blends, copolyester polycarbonates)), polystyrenes (e.g., copolymers of polycarbonate and styrene, polyphenylene ether-polystyrene blends), polyimides (e.g., polyetherimides), acrylonitrile-styrene-butadiene (ABS), polyalkylmethacrylates (e.g., polymethylmethacrylates), polyesters (e.g., copolyesters, polythioesters), polyolefins (e.g., polypropylenes and polyethylenes, high density polyethylenes, low density polyethylenes, linear low density polyethylenes), polyamides (e.g., polyamideimides), polyarylates, polysulfones (e.g., polyarylsulfones, polysulfonamides), polyphenylene sulfides, polytetrafluoroethylenes, polyethers (e.g., polyether ketones, polyether etherketones, polyethersulfones), acrylics, polyacrylics, polyacetals, polybenzoxazoles (e.g., polybenzothiazinophenothiazines, polybenzothiazoles), polyoxadiazoles, polypyrazinoquinoxalines, polypyromellitimides, polyquinoxalines, polybenzimidazoles, polyoxindoles, polyoxoisoindolines (e.g., polydioxoisoindolines), polytriazines, polypyridazines, polypiperazines, polypyridines, polypiperidines, polytriazoles, polypyrazoles, polypyrrolidines, polycarboranes, polyoxabicyclononanes, polydibenzofurans, polyphthalides, polyacetals, polyanhydrides, polyvinyls (e.g., polyvinyl ethers, polyvinyl thioethers, polyvinyl alcohols, polyvinyl ketones, polyvinyl halides, polyvinyl nitriles, polyvinyl esters, polyvinylchlorides), polysulfonates, polysulfides, polyureas, polyphosphazenes, polysilazzanes, polysiloxanes, or combinations comprising at least one of the foregoing.

More particularly, the thermoplastic polymers used in the thermoplastic sheet can include, but are not limited to, polycarbonate resins (e.g., LEXAN™ resins, commercially available from SABIC's Innovative Plastics business such as LEXAN™ XHT, LEXAN™ HFD, etc.), polyphenylene ether-polystyrene blends (e.g., NORYL™ resins, commercially available from SABIC's Innovative Plastics business), polyetherimide resins (e.g., ULTEM™ resins, commercially available from SABIC's Innovative Plastics business), polybutylene terephthalate-polycarbonate blends (e.g., XENOY™ resins, commercially available from SABIC's Innovative Plastics business), copolyestercarbonate resins (e.g. LEXAN™ SLX or LEXAN™ FST resins, commercially available from SABIC's Innovative Plastics business), acrylonitrile butadiene styrene resins (e.g., CYCOLOY™ resins, commercially available from SABIC's Innovative Plastics business), polyetherimide/siloxane resins (e.g., SILTEM™, commercially available from SABIC's Innovative Plastics business) and combinations comprising at least one of the foregoing resins. Even more particularly, the thermoplastic polymers can include, but are not limited to, homopolymers and copolymers of a polycarbonate, a polyester, a polyacrylate, a polyamide, a polyetherimide, a polyphenylene ether, or a combination comprising at least one of the foregoing polymers. The polycarbonate can comprise copolymers of polycarbonate (e.g., polycarbonate-polysiloxane, such as polycarbonate-polysiloxane block copolymer), linear polycarbonate, branched polycarbonate, end-capped polycarbonate (e.g., nitrile end-capped polycarbonate) blends of PC, such as PC/ABS blend, and combinations comprising at least one of the foregoing, for example a combination of branched and linear polycarbonate.

The thermoplastic sheet can, optionally, include various additives ordinarily incorporated into polymer compositions of this type, with the proviso that the additive(s) are selected so as to not significantly adversely affect the desired properties of the sheet, for example, flame retardance, smoke density, smoke toxicity, heat release, thermoformability, adhesion after thermoforming; hydrothermal resistance, water vapor transmission resistance, puncture resistance, and thermal shrinkage. Such additives can be mixed at a suitable time during the mixing of the components for forming the compositions of the substrate. Exemplary additives include impact modifiers, fillers, reinforcing agents, antioxidants, heat stabilizers, light stabilizers, ultraviolet (UV) light stabilizers, plasticizers, lubricants, mold release agents, antistatic agents, colorants (such as carbon black and organic dyes), surface effect additives, radiation stabilizers (e.g., infrared absorbing), flame retardants, and anti-drip agents. A combination of additives can be used, for example a combination of a flame retardant heat stabilizer, mold release agent, and ultraviolet light stabilizer. In general, the additives can be used in the amounts generally known to be effective. The total amount of additives (other than any impact modifier, filler, or reinforcing agents) can generally be 0.001 to 5 weight percent (wt. %), based on the total weight of the composition of the particular layer. The core layer and/or the cap layer(s) can also optionally, additionally, comprise a flame retardant. Flame retardants include organic and/or inorganic materials. Organic compounds include, for example, phosphorus, sulphonates, and/or halogenated materials (e.g., comprising bromine chlorine, and so forth, such as brominated polycarbonate). Non-brominated and non-chlorinated phosphorus-containing flame retardant additives can be preferred in certain applications for regulatory reasons, for example organic phosphates and organic compounds containing phosphorus-nitrogen bonds.

Inorganic flame retardants include, for example, C₁₋₁₆ alkyl sulfonate salts such as potassium perfluorobutane sulfonate (Rimar salt), potassium perfluoroctane sulfonate, tetraethyl ammonium perfluorohexane sulfonate, and potassium diphenylsulfone sulfonate (e.g., KSS); salts such as Na₂CO₃, K₂CO₃, MgCO₃, CaCO₃, and BaCO₃, or fluoro-anion complexes such as Li₃AlF₆, BaSiF₆, KBF₄, K₃AlF₆, KAlF₄, K₂SiF₆, and/or Na₃AlF₆. When present, inorganic flame retardant salts are present in amounts of 0.01 to 1 parts by weight, more specifically 0.02 to 0.5 parts by weight, based on 100 parts by weight of the total composition of the layer of the multilayer sheet in which it is included (i.e., the core layer), excluding any filler.

Anti-drip agents can also be used in the composition forming the substrate, for example a fibril forming fluoropolymer such as polytetrafluoroethylene (PTFE). The anti-drip agent can be encapsulated by a rigid copolymer, for example styrene-acrylonitrile copolymer (SAN). PTFE encapsulated in SAN is known as TSAN. An exemplary TSAN comprises 50 wt. % PTFE and 50 wt. % SAN, based on the total weight of the encapsulated fluoropolymer. The SAN can comprise, for example, 75 wt. % styrene and 25 wt. % acrylonitrile based on the total weight of the copolymer. Anti-drip agents can be used in amounts of 0.1 to 1 parts by weight, based on 100 parts by weight of the total composition of the particular layer, excluding any filler.

“Polycarbonate” as used herein means a polymer or copolymer having repeating structural carbonate units of formula (1)

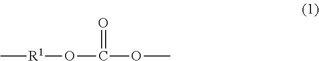

wherein at least 60 percent of the total number of R¹ groups are aromatic, or each R¹ contains at least one C₆₋₃₀ aromatic group. Specifically, each R¹ can be derived from a dihydroxy compound such as an aromatic dihydroxy compound of formula (2) or a bisphenol of formula (3).

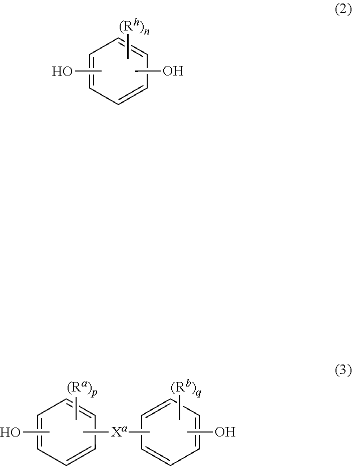

In formula (2), each R^{h} is independently a halogen atom, for example bromine, a C₁₋₁₀ hydrocarbyl group such as a C₁₋₁₀ alkyl, a halogen-substituted C₁₋₁₀ alkyl, a C₆₋₁₀ aryl, or a halogen-substituted C₆₋₁₀ aryl, and n is 0 to 4.

In formula (3), R^{a} and R^{b} are each independently a halogen, C₁₋₁₂ alkoxy, or C₁₋₁₂ alkyl, and p and q are each independently integers of 0 to 4, such that when p or q is less than 4, the valence of each carbon of the ring is filled by hydrogen. In an embodiment, p and q is each 0, or p and q is each 1, and R^{a} and R^{b} are each a C₁₋₃ alkyl group, specifically methyl, disposed meta to the hydroxy group on each arylene group. X^{a} is a bridging group connecting the two hydroxy-substituted aromatic groups, where the bridging group and the hydroxy substituent of each C₆ arylene group are disposed ortho, meta, or para (specifically para) to each other on the C₆ arylene group, for example, a single bond, —O—, —S—, —S(O)—, —S(O)₂-, —C(O)—, or a C₁₋₁₈ organic group, which can be cyclic or acyclic, aromatic or non-aromatic, and can further comprise heteroatoms such as halogens, oxygen, nitrogen, sulfur, silicon, or phosphorous. For example, X^{a} can be a substituted or unsubstituted C₃₋₁₈ cycloalkylidene; a C₁₋₂₅ alkylidene of the formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl; or a group of the formula —C(═R^{e})— wherein R^{e} is a divalent C₁₋₁₂ hydrocarbon group.

Examples of bisphenol compounds include 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole; resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like.

Specific dihydroxy compounds include resorcinol, 2,2-bis(4-hydroxyphenyl) propane (“bisphenol A” or “BPA”), 3,3-bis(4-hydroxyphenyl) phthalimidine, 2-phenyl-3,3′-bis(4-hydroxyphenyl) phthalimidine (also known as N-phenyl phenolphthalein bisphenol, “PPPBP”, or 3,3-bis(4-hydroxyphenyl)-2-phenylisoindolin-1-one), 1,1-bis(4-hydroxy-3-methylphenyl)cyclohexane, and 1,1-bis(4-hydroxyphenyl)-3,3,5-trimethylcyclohexane (isophorone bisphenol).

“Polycarbonate” as used herein also includes copolymers comprising carbonate units and ester units (“poly(ester-carbonate)s”, also known as polyester-polycarbonates). Poly(ester-carbonate)s further contain, in addition to recurring carbonate chain units of formula (1), repeating ester units of formula (4)

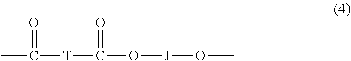

wherein J is a divalent group derived from a dihydroxy compound (which includes a reactive derivative thereof), and can be, for example, a C₂₋₁₀ alkylene, a C₆₋₂₀ cycloalkylene a C₆₋₂₀ arylene, or a polyoxyalkylene group in which the alkylene groups contain 2 to 6 carbon atoms, specifically, 2, 3, or 4 carbon atoms; and T is a divalent group derived from a dicarboxylic acid (which includes a reactive derivative thereof), and can be, for example, a C₂₋₂₀ alkylene, a C₆₋₂₀ cycloalkylene, or a C₆₋₂₀ arylene. Copolyesters containing a combination of different T or J groups can be used. The polyester units can be branched or linear.

Specific dihydroxy compounds include aromatic dihydroxy compounds of formula (2) (e.g., resorcinol), bisphenols of formula (3) (e.g., bisphenol A), a C₁₋₈ aliphatic diol such as ethane diol, n-propane diol, i-propane diol, 1,4-butane diol, 1,6-cyclohexane diol, 1,6-hydroxymethylcyclohexane, or a combination comprising at least one of the foregoing dihydroxy compounds. Aliphatic dicarboxylic acids that can be used include C₆₋₂₀ aliphatic dicarboxylic acids (which includes the terminal carboxyl groups), specifically linear C₈₋₁₂ aliphatic dicarboxylic acid such as decanedioic acid (sebacic acid); and alpha, omega-C₁₂ dicarboxylic acids such as dodecanedioic acid (DDDA). Aromatic dicarboxylic acids that can be used include terephthalic acid, isophthalic acid, naphthalene dicarboxylic acid, 1,6-cyclohexane dicarboxylic acid, or a combination comprising at least one of the foregoing acids. A combination of isophthalic acid and terephthalic acid wherein the weight ratio of isophthalic acid to terephthalic acid is 91:9 to 2:98 can be used.

Specific ester units include ethylene terephthalate units, n-propylene terephthalate units, n-butylene terephthalate units, ester units derived from isophthalic acid, terephthalic acid, and resorcinol (ITR ester units), and ester units derived from sebacic acid and bisphenol A. The molar ratio of ester units to carbonate units in the poly(ester-carbonate)s can vary broadly, for example 1:99 to 99:1, specifically, 10:90 to 90:10, more specifically, 25:75 to 75:25, or from 2:98 to 15:85. In some embodiments the molar ratio of ester units to carbonate units in the poly(ester-carbonate)s can vary from 1:99 to 30:70, specifically 2:98 to 25:75, more specifically 3:97 to 20:80, or from 5:95 to 15:85.

In a specific embodiment, the polycarbonate is a linear homopolymer containing bisphenol A carbonate units (BPA-PC); or a branched, cyanophenol end-capped bisphenol A homopolycarbonate produced via interfacial polymerization, containing 3 mol % 1,1,1-tris(4-hydroxyphenyl)ethane (THPE) branching agent, commercially available under the trade name CFR from the Innovative Plastics division of SABIC.

In another embodiment, the polycarbonate is a poly(carbonate-siloxane) copolymer comprising bisphenol A carbonate units and siloxane units, for example blocks containing 5 to 200 dimethylsiloxane units, such as those commercially available under the trade name EXL from the Innovative Plastics division of SABIC.

Other specific polycarbonates that can be used include poly(ester-carbonate)s comprising bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units.

Other specific polycarbonates that can be used include poly(ester-carbonate-siloxane)s comprising bisphenol A carbonate units, isophthalate-terephthalate-bisphenol A ester units, and siloxane units, for example blocks containing 5 to 200 dimethylsiloxane units, such as those commercially available under the trade name FST from the Innovative Plastics division of SABIC.

Poly(aliphatic ester-carbonate)s can be used, such as those comprising bisphenol A carbonate units and sebacic acid-bisphenol A ester units, such as those commercially available under the trade name LEXAN™ HFD from the Innovative Plastics division of SABIC.

A specific copolycarbonate includes bisphenol A and bulky bisphenol carbonate units, i.e., derived from bisphenols containing at least 12 carbon atoms, for example 12 to 60 carbon atoms or 20 to 40 carbon atoms. Examples of such copolycarbonates include copolycarbonates comprising bisphenol A carbonate units and 2-phenyl-3,3′-bis(4-hydroxyphenyl) phthalimidine carbonate units (a BPA-PPPBP copolymer, commercially available under the trade designation XHT from the Innovative Plastics division of SABIC), a copolymer comprising bisphenol A carbonate units and 1,1-bis(4-hydroxy-3-methylphenyl)cyclohexane carbonate units (a BPA-DMBPC copolymer commercially available under the trade designation DMC from the Innovative Plastics division of SABIC), and a copolymer comprising bisphenol A carbonate units and isophorone bisphenol carbonate units (available, for example, under the trade name APEC from Bayer).

It is also possible to employ two or more different dihydric phenols in the event a polycarbonate copolymer or interpolymer rather than a homopolymer is desired. Polycarbonate copolymers can include two or more different types of carbonate units, for example units derived from BPA and PPPBP (commercially available under the trade designation XHT from the Innovative Plastics division of SABIC); BPA and DMBPC (commercially available under the trade designation DMX from the Innovative Plastics division of SABIC); or BPA and isophorone bisphenol (commercially available under the trade name APEC from Bayer). The polycarbonate copolymers can further comprise non-carbonate repeating units, for example repeating ester units (polyester-carbonates), such as those comprising bisphenol A carbonate units and isophthalate-terephthalate-bisphenol A ester units, also commonly referred to as poly(carbonate-ester)s (PCE) or poly(phthalate-carbonate)s (PPC), depending on the relative ratio of carbonate units and ester units, or those comprising bisphenol A carbonate units and C₆₋₁₂ dicarboxy ester units (commercially available under the trade designation HFD from the Innovative Plastics division of SABIC); repeating siloxane units (polycarbonate-siloxanes), for example those comprising bisphenol A carbonate units, isophthalate-terephthalate-bisphenol A ester units, and siloxane units (e.g., blocks containing 5 to 200 dimethylsiloxane units), such as those commercially available under the trade name FST from the Innovative Plastics division of SABIC; or both ester units and siloxane units (polycarbonate-ester-siloxanes), for example those comprising bisphenol A carbonate units, isophthalate-terephthalate-bisphenol A ester units, and siloxane units (e.g., blocks containing 5 to 200 dimethylsiloxane units), such as those commercially available under the trade name FST from the Innovative Plastics division of SABIC. Branched polycarbonates are also useful, such as are described in U.S. Pat. No. 4,001,184, or highly-branched polycarbonate homopolymers containing cyanophenol endcaps, such as those commercially available under the trade designation CFR from the Innovative Plastics division of SABIC. Also, there can be utilized combinations of linear polycarbonate and a branched polycarbonate. Moreover, combinations of any of the above materials may be used.

Co-extrusion methods and/or coating methods (on-and-off line) can also be employed during the production of the thermoplastic sheet to supply different polymers to any surface portion of the sheet's geometry, to improve and/or alter the performance of the thermoplastic sheet, and/or to reduce raw material costs. For example, co-extrusion methods can be used to apply a cap layer to one or both sides of the sheet. In one embodiment, a co-extrusion process can be employed to add an aesthetic colorant to the top layer. A coating(s) can be disposed on any of the sheet's surfaces to improve the sheet's performance and/or properties. Exemplary coatings or co-extrusion layers can comprise antifungal coatings, hydrophobic coatings, hydrophilic coatings, light dispersion coatings, anti-condensation coatings, scratch resistant coatings, ultraviolet absorbing coatings, light stabilizer coatings, and the like. It is to be apparent to those skilled in the art of co-extrusion that a myriad of embodiments can be produced utilizing the co-extrusion process.

The thermoplastic sheet can be co-extruded with other layer(s), i.e., a multilayer sheet. For example, as mentioned, the thermoplastic sheet can also, optionally, comprise cap layer(s). The thermoplastic sheet can be co-extruded, laminated, glued, etc., with a cap-layer that can be located adjacent any side of the lightweight sheet (e.g., top, bottom, and/or the side(s)). In general the cap layer can be of any thickness, and distributed front-to-back, or side-to-front-to-back, meeting requirements of density, mechanical properties, forming, texturing, aesthetics, etc. The various layers, when present, can comprise the same or different materials. A cap layer(s) can optionally comprise UV absorber(s) and other additives, organic or inorganic to customized performance, as previously described if desired for the end use application.

It is further contemplated that the thermoplastic polymeric sheet can comprise additional layers (e.g., greater than or equal to additional layers). Additionally, the thermoplastic polymeric sheet can also comprise layers dispersed between the various layers, for example, an interlayer or an adhesive layer, such that a core layer can then be in contact with the interlayer and the interlayer can be in contact with a cap layer, or any combination thereof. Additional layers or coatings can also be present on the surface of any cap layers (such that the cap layer is between the coating and the core layer). Such layers can include, but are not limited to, hardcoats (e.g., an abrasion resistant coating), UV resistant layers, IR absorbing layers, etc. The additional layers contemplated can be added with the proviso that they not adversely affect the desired properties of the multilayer sheet. Any feasible combination of the above described additional layers is also contemplated.

The masking film can have a thickness of 10 micrometers to 150 micrometers, for example, 15 micrometers to 150 micrometers, for example, 20 micrometers to 125 micrometers, for example, 25 micrometers to 75 micrometers, for example, 30 to 50 micrometers.

The thermoplastic sheet can have a thickness of 0.05 millimeter to 20 millimeters, for example, 0.10 millimeter to 15 millimeters, for example, 0.15 millimeters to 10 millimeters, for example, 0.8 millimeters to 5 millimeters, for example, 1.0 millimeters to 2.5 millimeters. In an embodiment, the thermoplastic sheet can have a thickness of 0.15 millimeter to 15 millimeters.

A more complete understanding of the components, processes, and apparatuses disclosed herein can be obtained by reference to the accompanying drawings. These figures (also referred to herein as “FIG.”) are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

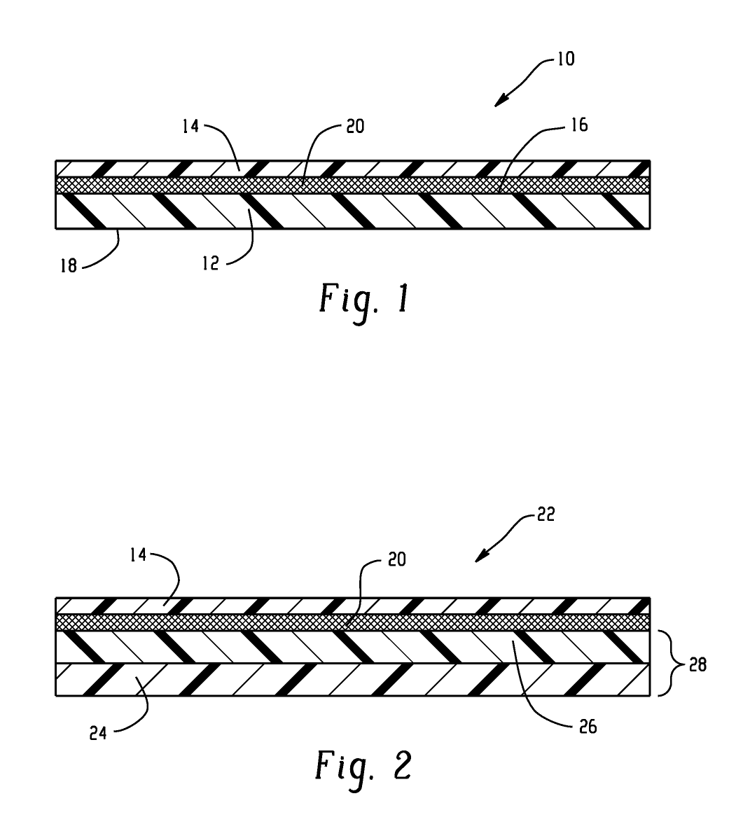

As can be seen in FIG. 1, a thermoplastic sheet 10 can include a substrate 12 and a masking film 14, wherein the masking film is disposed across a surface of the substrate 12. The substrate can include a substrate first surface 16 and a substrate second surface 18. The masking film 14 can be disposed across a portion of the substrate first surface 16, or the masking film 14 can be disposed across the entire substrate first surface 16. Optionally, an adhesive 20 can be disposed between the masking film 14 and the substrate 12.

In FIG. 2, a thermoplastic sheet 22 is shown. The thermoplastic sheet 22 can include a substrate comprising a core layer 24 and a cap layer 26 forming substrate 28 with a masking film 14 that can be dispersed across a portion of the cap layer 26, or the masking film can be disposed across the entire cap layer 26. Optionally, an adhesive 20 can be disposed between the substrate 28 and the masking film 14.

The following example is merely illustrative of the thermoforming method disclosed herein and is not intended to limit the scope hereof.

### EXAMPLES

### Example 1

Various samples were prepared using commercially available extruded thermoplastic sheets. Samples 1 to 6 used Substrate Sheet 1 and Samples 7 to 12 used Substrate Sheet 2. Samples 1 and 7 contained no masking. Samples 2 and 8 contained Masking A, Samples 3 and 9 contained Masking B, Samples 4 and 10 contained Masking C, Samples 5 and 11 contained Masking D, and Samples 6 and 12 contained Masking E. The thermoplastic substrate sheet was cleaned prior to application of the masking film. Accordingly, all attached dust was blown off the surface of the thermoplastic substrate sheet using ionized air to neutralize the substrate surface. These measures were taken to ensure essentially no dust was present or could be attracted to the surface of the thermoplastic substrate sheet prior to application of the masking film. The masking film had an adhesive layer on one surface and was manually applied to an opposite surface of the thermoplastic sheet with some pressure and care taken to ensure no air entrapped between the masking film and the thermoplastic sheet. After adhering the thermoplastic sheet to the masking film, the laminated substrate was dried for four hours at 120° C. in a circulating drying air oven. After removing the laminated substrate from the oven, the outer surface of the masking film was intentionally contaminated with dust particles from the environment. The thermoplastic substrate sheet was then thermoformed at 210° C. using a small thermoforming machine (Illig Machinenbau GmbH & Co., type KFG370, equipped with 10 ceramic heater elements (4 at 325 Watts; 6 at 200 Watts)) forming a thermoplastic three dimensional part, e.g., an article having dimensions of 100 millimeters (mm)×200 mm Following the thermoforming treatment, the thermoplastic part was allowed to cool to room temperature. The masking film was then manually removed to assess whether blue discoloration spots had formed on the surface of the thermoplastic part underneath the masking film during the thermoforming process. The results are illustrated in Tables 2 and 3.

Substrate Sheet 1 comprised a commercially available grade of polycarbonate sheet from SABIC, LEXAN™ XHR6006, which is an opaque aircraft sheet grade offering robust Fire/Smoke/HeatRelease OSU 65/65 compliancy per FAR 25.853 and meeting toxicity requirements of Airbus ABD0031/Boeing DSS7239 along with the advantages of lower weight, lower processing temperatures, improved ductility, and improved colorability versus polyvinyl chloride or acrylic polymers. Substrate Sheet 2 comprised a commercially available grade of polycarbonate sheet from SABIC, LEXAN™, F6006, which is a high impact, flame retardant opaque sheet used in applications as diverse as aircraft interior cladding, electronic housings, and train seat cladding. This material is fire/smoke compliant per FAR 25.853 and meeting toxicity requirements of Airbus ABD0031/Boeing DSS7239. The substrate sheets were 2.0 millimeters (mm) thick.

TABLE 1
Materials

| Name | Description | Source |
|---|---|---|
| Substrate | LEXAN ™ XHR6006 polycarbonate sheet | SABIC |
| Sheet 1 | | |
| Substrate | LEXAN ™ F6006 polycarbonate sheet | SABIC |
| Sheet 2 | | |
| Masking A | SK 7XB120KKN/X, 50 micrometer, polyolefin | Bischof + Klein GmbH |
| | (PE) based, rubber based glue | & Co. KG |
| Masking B | SK ENW K19, 50 micrometer, poly(hexane-6- | Bischof + Klein GmbH |
| | lactam) (PA6) based, rubber glue coating | & Co. KG |
| Masking C | ET 2360AD68S3/X, 50 micrometer, polyethylene | Bischof + Klein GmbH |
| | terephthalate (PET) based, acrylic adhesive coating | & Co. KG |
| Masking D | TD5025-012A, 50 micrometer, polyethylene | Guangdong Tamay |
| | terephthalate (PET) based, acrylic adhesive coating | New Materials Co., Ltd |
| Masking E | Ethylene vinyl alcohol (EVOH) based | Polifilm |

TABLE 2
Results for Substrate Sheet 1

| | Sample # | | | | | |
|---|---|---|---|---|---|---|
| | 1 | 2 | 3 | 4 | 5 | 6 |
| Masking Type | None | A | B | C | D | E |
| Blue Spots in Masking Film | N/A | Yes | No | Yes | Yes | Yes |
| Blue Spots on Substrate Sheet | Yes | Yes | No | No | No | Yes |
| 1 | | | | | | |
| Good Initial Adhesion | N/A | Yes | Yes | Yes | Yes | Yes |
| Thermoformable | N/A | Yes | Yes | No | No* | No |
| Residual Adhesive on Sub- | N/A | Yes | Yes | No | No | Yes |
| strate | | | | | | |
| Masking Removed Easily | N/A | Yes | Yes | Yes | Yes | Yes |

TABLE 3
Results for Substrate Sheet 2

| | Sample # | | | | | |
|---|---|---|---|---|---|---|
| | 7 | 8 | 9 | 10 | 11 | 12 |
| Masking Type | None | A | B | C | D | E |
| Blue Spots in Masking Film | N/A | Yes | No | Yes | Yes | Yes |
| Blue Spots on Substrate Sheet | Yes | Yes | No | Yes | No | Yes |
| 2 | | | | | | |
| Good Initial Adhesion | N/A | Yes | Yes | Yes | Yes | Yes |
| Thermoformable | N/A | Yes | Yes | No | No* | No |
| Residual Adhesive on Sub- | N/A | Yes | Yes | No | No | Yes |
| strate | | | | | | |
| Masking Removed Easily | N/A | Yes | Yes | Yes | Yes | Yes |

*In these examples, the masking did not degrade during thermoforming, but it did affect the substrate surface negatively and irreversibly. Hence, the masking is not thermoformable per se.

Masking B (the PA6 based masking), Samples 3 and 9, provided a high level of protection against the formation of blue discoloration spots. This high level of protection was clearly demonstrated when Masking B was compared to the control case (where no masking was used at all), Sample 1 and to the case where Masking A (the PE based masking), Samples 2 and 8 was used. In Samples 1 and 7, when no masking was used, blue discoloration spots formed easily on the surface of the thermoplastic substrate. In Samples 2 and 8, the PE masking was also not effective and did not prevent the formation of blue discoloration spots. Blue colorants within the dust and textile fibers diffused through the masking and towards the thermoplastic substrate. In contrast, Samples 3 and 9 containing the PA6 masking was not susceptible to diffused dyes. It is believed that the PA6 masking prevented the formation of blue discoloration spots. The PA6 masking also prevented formation of blue discoloration spots within the masking itself. Accordingly, the PA6 masking was surprisingly shown to have a high resistance to the colorants within dust and textile fibers. Samples 4 and 11, containing Masking D (the PET based masking obtained from Guangdong Tamay New Materials Co., Ltd) also demonstrated a high level of substrate protection from blue discoloration spots.

### Example 2

In this example, the masking films were tested on injection molded specimen, molded from compositions listed in Table 5 under more defined and controlled conditions. Compositions of Molding 1 and Molding 2 are similar to the compositions of the commercial substrate sheet produ]cts tested in Example 1 (respectively Substrate Sheet 1 and Substrate Sheet 2).

TABLE 4
Materials

| Description | CAS | Supplier |
|---|---|---|
| PC105 resin - linear Lexan PC resin/phenol | 25971-63-5 | SABIC |
| end-capped | | |
| FST resin - Poly(ester-carbonate-siloxane)s | 915977-87-6 | SABIC |
| 105B resin - brominated PC resin | 156042-31-8 | SABIC |
| Antioxidant Irgafos 168 | 31570-04-4 | BASF |
| Antioxidant Irgafos P-EPQ | 119345-01-6 | BASF |
| STB FR - 2,4,5-trichlorobenzene | 53423-65-7 | ARICHEM |
| sodiumsulphonate | | |
| Encapsulated PTFE - TSAN antidrip | 9002-84-0 | SABIC |
| Coated Titanium Dioxide | 13463-67-7 | KRONOS |

TABLE 5
Compositions for Substrate Moldings

| | | Molding 2 |
|---|---|---|
| Description | Molding 1 (%) | (%) |
| FST Resin | 85.94 | |
| PC105 | | 97.95 |
| 105B resin | 12 | |
| Antioxidant Tris(di-t-butylphenyl)phosphite | | 0.05 |
| Phosphonite PEPQ | 0.06 | |
| Coated Titanium Dioxide | 2 | 2 |

All formulations from Table 5 were compounded on a Werner & Pfleiderer ZSK 25 mm co-rotating twin screw extruder (barrel temperature of 240-300° C.; 300 revolutions per minute screw speed; material produced was throughput at 16 kilograms per hour (kg/hr)). Following, the obtained compounds were pre-dried at 120° C. fort hours and injection molded on an Engel 75 ton injection molding machine into color plaques having dimensions of 60 mm×60 mm×2.5 mm, a barrel temperature of 290-310° C., and a mold temperature of 100° C.

Similarly as in Example 1, the injection molded plaques were cleaned prior to application of the masking film. Accordingly, all attached dust was blown off the surface of the thermoplastic substrate sheet using ionized air to ensure no static charge was present. These measures were taken to ensure essentially no dust was present on or attracted to the surface of the thermoplastic substrate molding prior to application of the masking film. The masking film had an adhesive layer on one surface and was manually applied to an opposite surface of the substrate molding with some pressure to ensure that no air was entrapped between the masking film and the thermoplastic substrate sheet. Subsequently, the outer surface of the masking film was then intentionally contaminated with dark blue jeans fibers (isolated from jeans with a dust collector), closed with a petri dish, and put into an oven at 170° C. for 30 minutes (Thermo Scientific, Heratherm OMH60). Following the oven treatment, the thermoplastic part was allowed to cool to room temperature. The masking film was then manually removed from the molded plaque to assess whether blue discoloration spots had formed on the surface of the thermoplastic part underneath the masking upon the heat treatment.

Samples 13 and 19 are the substrates without Masking, Samples 14 and 20 contained Masking A, Samples 15 and 21 contained Masking B, Samples 16 and 22 contained Masking C, Samples 17 and 23 contained Masking D, and Samples 18 and 24 contained Masking E. The results are illustrated in Tables 6 and 7 with results for Substrate Molding 1 listed in Table 6 and results for Substrate Molding 2 listed in Table 7.

TABLE 6
Results for Substrate Molding 1

| | Sample # | | | | | |
|---|---|---|---|---|---|---|
| | 13 | 14 | 15 | 16 | 17 | 18 |
| Masking Type | None | A | B | C | D | E |
| Blue Spots in | N/A | Yes | No | Yes | Yes | Yes |
| Masking Film | | | | | | |
| Blue Spots on | Yes | Yes | No | No | No | Yes |
| Substrate | | | | | | |
| Sheet 1 | | | | | | |
| Notes | N/A | No Ad- | Resid- | Surface | Surface | Masking |
| | | hesive | ual ad- | defor- | defor- | defor- |
| | | residue | hesive | mation | mation | mation |

TABLE 7
Results for Substrate Molding 2

| | Sample # | | | | | |
|---|---|---|---|---|---|---|
| | 19 | 20 | 21 | 22 | 23 | 24 |
| Masking Type | None | A | B | C | D | E |
| Blue Spots in | N/A | Yes | No | Yes | Yes | Yes |
| Masking Film | | | | | | |
| Blue Spots on | Yes | Yes | No | Yes | No | Yes |
| Substrate | | | | | | |
| Sheet 2 | | | | | | |
| Notes | N/A | No Ad- | Resid- | Surface | Surface | Masking |
| | | hesive | ual ad- | defor- | defor- | defor- |
| | | residue | hesive | mation | mation | mation |

The level of protection caused by the different maskings was found to be identical to the thermoformed combinations of materials as described in Example 1. Without masking, Samples 13 and 19, both Substrate Molding 1 and 2 easily formed blue spots when the surface was intentionally contaminated with the jeans fibers after the oven treatment. Masking B (the PA6 based masking), Samples 15 and 21, provided the highest level of protection against the formation of blue discoloration spots. This high level of protection was clearly demonstrated when Masking B was compared to the case where Masking A (the PE based masking), Samples 14 and 20 was used. Blue colorants within the dust and textile fibers diffused through the PE masking towards the thermoplastic substrate. In contrast, Samples 15 and 21, containing the PA6 masking was not susceptible to diffused dyes. Without wishing to be limited by theory, it is believed that the PA6 masking prevented the formation of blue discoloration spots. The PA6 masking also prevented formation of blue discoloration spots within the masking itself. Accordingly, the PA6 masking was surprisingly shown to have a high resistance to the colorants within dust and textile fibers. Samples 17 and 23, containing Masking D (PET based masking obtained from Guangdong Tamay New Materials Co., Ltd) also demonstrated a high level of substrate protection from blue discoloration spots, but caused the substrate surface to deform under the applied conditions.

### Example 3

In this example, various types of commercially available polyamides were evaluated for their intrinsic ability to protect against formation of blue spots. The different polyamides are listed in Table 8.

The polyamide resins were individually pressed on a Specac Pellet Press equipped with a Constant Thickness Film Maker Accessory into thin films (20 micrometers (μm) thick) between polytetrafluorethylene, i.e., TEFLON™, coated aluminum foil at different temperatures as illustrated in Table 8. The cycle included pre-heating for 1 minute, followed by pressurizing for one minute at 2.5 bar (250 kiloPascals). Subsequently, the resulting film was isolated from the aluminum foil and allowed to cool down. Then the film was intentionally contaminated with dark blue jeans fibers (isolated from jeans with a dust collector), closed with a petri dish, and put into an oven at 170° C. for 30 minutes, after which it was cool to room temperature. The film was then assessed as to whether blue discoloration spots had formed on the surface upon the thermal treatment. The results are listed in Table 9.

TABLE 8
Different Polyamides

| | Name | Description | Source |
|---|---|---|---|
| F | Zytel 151L NC010 | PA6,12 | Dupont |
| G | Zytel HTN 501 | PA6T/XT | Dupont |
| H | Amodel A1006 | PPA | Solvay |
| I | Rilsan besvo AFDS | PA11 | Arkema |
| J | Tarnamid T27 | PA6 | Azoty Tarnow |
| K | Stabamid 26JE1 | PA6,6 | Rhodia |
| L | Zytel RS LC3030 | PA6,10 | Dupont |
| M | Stabamid 27AE1 | PA6,6 | Rhodia |
| N | Vestamid L1700 | PA12 | Evonik |
| O | Stanyl KS300 | PA4,6 (Glassfilled) | DSM |

TABLE 9
results of different polyamides

| | Sample # | | | | | | | | | |
|---|---|---|---|---|---|---|---|---|---|---|
| | 25 | 26 | 27 | 28 | 29 | 30 | 31 | 32 | 33 | 34 |
| Polyamide Type | F | G | H | I | J | K | L | M | N | O |
| Film pressing | 210 | 280 | 230 | 205 | 220 | 250 | 215 | 250 | 200 | 260 |
| temperature (° C.) | | | | | | | | | | |
| Blue Spots | No | No | No | No | No | No | No | No | No | No |
| Formed in PA film | | | | | | | | | | |

From the results it can be concluded that none of the polyamides tested formed blue spots and that polyamides in general give excellent protection against the formation of blue spots.

The thermoplastic sheets and methods of making thereof disclosed herein include(s) at least the following embodiments:

### Embodiment 1

A thermoplastic sheet, comprising: a thermoplastic substrate; and a masking film applied to a surface of the thermoplastic substrate; wherein the masking film comprises a polyamide, a polyester, or a combination comprising at least one of the foregoing; wherein after thermoforming the thermoplastic sheet, the thermoplastic sheet and the masking film are free from discolorations.

### Embodiment 2

The thermoplastic sheet of Embodiment 1, wherein the masking film comprises aliphatic polyamide, polythalamide, aromatic polyamide, or a combination comprising at least one of the foregoing.

### Embodiment 3

The thermoplastic sheet of Embodiment 1 or Embodiment 2, wherein the masking film comprises polyamide-6, polyamide 6,6, polyamide-6,10, polyamide 6,12, polyamide-11, polyamide-12, polyamide 4,6, polyamide 6T/XT, high performance polyamide (PPA), or a combination comprising at least one of the foregoing.

### Embodiment 4

The thermoplastic sheet of any of the preceding embodiments, wherein the masking film comprises polyamide-6, polyamide-6,6, or a combination comprising at least one of the foregoing.

### Embodiment 5

The thermoplastic sheet of any of the preceding embodiments, wherein the masking film comprises polyethylene terephthalate.

### Embodiment 6

The thermoplastic sheet of any of the preceding embodiments, wherein the thermoplastic sheet can be thermoformed to form an article.

### Embodiment 7

The thermoplastic sheet of any of the preceding embodiments, wherein the surface of the thermoplastic sheet is free from discolorations caused by dust particles.

### Embodiment 8

The thermoplastic sheet of any of the preceding embodiments, wherein the surface of the thermoplastic sheet is free from blue discolorations.

### Embodiment 9

The thermoplastic sheet of any of the preceding embodiments, wherein the thermoplastic substrate is formed via an extrusion process or via a co-extrusion process.

### Embodiment 10

The thermoplastic sheet of any of the preceding embodiments, wherein the thermoplastic substrate comprises polycarbonate, polystyrene, acrylonitrile-styrene-butadiene, polyphenylene ether-polystyrene, polyalkylmethacrylate, polyester, polyolefin, polyamide, polyethers, fluoropolymer, polyvinyl fluoride, polyvinylidene fluoride, polychlorotrifluoroethylene, polyvinyl chloride, acrylic, or a combination comprising at least one of the foregoing.

### Embodiment 11

The thermoplastic sheet of any of the preceding embodiments, wherein the thermoplastic substrate comprises polycarbonate, copolymers of polycarbonate, or a combination comprising at least one of the foregoing.

### Embodiment 12

The thermoplastic sheet of Embodiment 11, wherein the polycarbonate includes bisphenol-A polycarbonate, dimethyl bisphenol cyclohexane polycarbonate, or combinations comprising at least one of the foregoing.

### Embodiment 13

The thermoplastic sheet of any of the preceding embodiments, wherein the masking film is applied to the surface of the thermoplastic substrate via spraying, painting, coating, laminating, or a combination comprising at least one of the foregoing.

### Embodiment 14

The thermoplastic sheet of any of the preceding embodiments, wherein the masking film has a thickness of 10 micrometers to 100 micrometers on the surface of the thermoplastic substrate.

### Embodiment 15

The thermoplastic sheet of any of the preceding embodiments, wherein the thermoplastic substrate has a thickness of 0.15 millimeter to 20 millimeters.

### Embodiment 16

The thermoplastic sheet of any of the preceding embodiments, wherein the masking film is coated with a rubber based glue, an acrylic adhesive, or a combination comprising at least one of the foregoing.

### Embodiment 17

The thermoplastic sheet of any of the preceding embodiments, wherein the article is a panel for use in an automobile, aircraft, or railway.

### Embodiment 18

The thermoplastic sheet of Embodiment 5, wherein the masking film can be removed from the surface of the article at room temperature via scraping, peeling, or a combination comprising at least one of the forgoing.

### Embodiment 19

A method of thermoforming an article, comprising: extruding a thermoplastic sheet; applying a masking film to a surface of the thermoplastic sheet, wherein the masking film comprises a polyamide, a polyester, or a combination comprising at least one of the foregoing; shaping the thermoplastic sheet to form the article, wherein the masking film remains in contact with the surface of the thermoplastic sheet during shaping; and after cooling the article, removing the masking film from a surface of the article.

### Embodiment 20

The method of Embodiment 19, wherein the masking film is applied to the surface of the thermoplastic sheet at room temperature or wherein the masking film is applied to the surface of the thermoplastic sheet continuously during extrusion of the thermoplastic sheet.

In general, the invention may alternately comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function and/or objectives of the present invention. The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. “Or” means “and/or.” The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

The modifier “about” used in connection with a quantity is inclusive of the stated value and has the meaning dictated by the context (e.g., includes the degree of error associated with measurement of the particular quantity). The notation “±10%” means that the indicated measurement can be from an amount that is minus 10% to an amount that is plus 10% of the stated value. The terms “front”, “back”, “bottom”, and/or “top” are used herein, unless otherwise noted, merely for convenience of description, and are not limited to any one position or spatial orientation. “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs. A “combination” is inclusive of blends, mixtures, alloys, reaction products, and the like.

As used herein, the term “hydrocarbyl” and “hydrocarbon” refers broadly to a substituent comprising carbon and hydrogen, optionally with 1 to 3 heteroatoms, for example, oxygen, nitrogen, halogen, silicon, sulfur, or a combination thereof; “alkyl” refers to a straight or branched chain, saturated monovalent hydrocarbon group; “alkylene” refers to a straight or branched chain, saturated, divalent hydrocarbon group; “alkylidene” refers to a straight or branched chain, saturated divalent hydrocarbon group, with both valences on a single common carbon atom; “alkenyl” refers to a straight or branched chain monovalent hydrocarbon group having at least two carbons joined by a carbon-carbon double bond; “cycloalkyl” refers to a non-aromatic monovalent monocyclic or multicylic hydrocarbon group having at least three carbon atoms, “cycloalkenyl” refers to a non-aromatic cyclic divalent hydrocarbon group having at least three carbon atoms, with at least one degree of unsaturation; “aryl” refers to an aromatic monovalent group containing only carbon in the aromatic ring or rings; “arylene” refers to an aromatic divalent group containing only carbon in the aromatic ring or rings; “alkylaryl” refers to an aryl group that has been substituted with an alkyl group as defined above, with 4-methylphenyl being an exemplary alkylaryl group; “arylalkyl” refers to an alkyl group that has been substituted with an aryl group as defined above, with benzyl being an exemplary arylalkyl group; “acyl” refers to an alkyl group as defined above with the indicated number of carbon atoms attached through a carbonyl carbon bridge (—C(═O)—); “alkoxy” refers to an alkyl group as defined above with the indicated number of carbon atoms attached through an oxygen bridge (—O—); and “aryloxy” refers to an aryl group as defined above with the indicated number of carbon atoms attached through an oxygen bridge (—O—).

Unless otherwise indicated, each of the foregoing groups can be unsubstituted or substituted, provided that the substitution does not significantly adversely affect synthesis, stability, or use of the compound. The term “substituted” as used herein means that at least one hydrogen on the designated atom or group is replaced with another group, provided that the designated atom's normal valence is not exceeded. When the substituent is oxo (i.e., ═O), then two hydrogens on the atom are replaced. Combinations of substituents and/or variables are permissible provided that the substitutions do not significantly adversely affect synthesis or use of the compound. Exemplary groups that can be present on a “substituted” position include, but are not limited to, cyano; hydroxyl; nitro; azido; alkanoyl (such as a C₂₋₆ alkanoyl group such as acyl); carboxamido; C₁₋₆ or C₁₋₃ alkyl, cycloalkyl, alkenyl, and alkynyl (including groups having at least one unsaturated linkages and from 2 to 8, or 2 to 6 carbon atoms); C₁₋₆ or C₁₋₃ alkoxys; C₆₋₁₀ aryloxy such as phenoxy; C₁₋₆ alkylthio; C₁₋₆ or C₁₋₃ alkylsulfinyl; C₁₋₆ or C₁₋₃ alkylsulfonyl; aminodi(C₁₋₆ or C₁₋₃)alkyl; C₆₋₁₂ aryl having at least one aromatic rings (e.g., phenyl, biphenyl, naphthyl, or the like, each ring either substituted or unsubstituted aromatic); C₇₋₁₉ arylalkyl having 1 to 3 separate or fused rings and from 6 to 18 ring carbon atoms; or arylalkoxy having 1 to 3 separate or fused rings and from 6 to 18 ring carbon atoms, with benzyloxy being an exemplary arylalkoxy.

All cited patents, patent applications, and other references are incorporated herein by reference in their entirety. However, if a term in the present application contradicts or conflicts with a term in the incorporated reference, the term from the present application takes precedence over the conflicting term from the incorporated reference

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic sheet, comprising:
a thermoplastic substrate; and
a masking film applied to a surface of the thermoplastic substrate;
wherein the masking film comprises a polyamide, a polyester, or a combination comprising at least one of the foregoing;
wherein after thermoforming the thermoplastic sheet, the thermoplastic sheet and the masking film are free from discolorations.

2. The thermoplastic sheet of claim 1, wherein the masking film comprises aliphatic polyamide, polythalamide, aromatic polyamide, or a combination comprising at least one of the foregoing.

3. The thermoplastic sheet of claim 1, wherein the masking film comprises polyamide-6, polyamide 6,6, polyamide-6,10, polyamide 6,12, polyamide-11, polyamide-12, polyamide 4,6, polyamide 6T/XT, high performance polyamide (PPA), or a combination comprising at least one of the foregoing.

4. The thermoplastic sheet of claim 1, wherein the masking film comprises polyamide-6, polyamide-6,6, or a combination comprising at least one of the foregoing.

5. The thermoplastic sheet of claim 1, wherein the masking film comprises polyethylene terephthalate.

6. The thermoplastic sheet of claim 1, wherein the thermoplastic sheet can be thermoformed to form an article.

7. The thermoplastic sheet of claim 1, wherein the surface of the thermoplastic sheet is free from discolorations caused by dust particles.

8. The thermoplastic sheet of claim 1, wherein the surface of the thermoplastic sheet is free from blue discolorations.

9. The thermoplastic sheet of claim 1, wherein the thermoplastic substrate is formed via an extrusion process or via a co-extrusion process.

10. The thermoplastic sheet of claim 1, wherein the thermoplastic substrate comprises polycarbonate, polystyrene, acrylonitrile-styrene-butadiene, polyphenylene ether-polystyrene, polyalkylmethacrylate, polyester, polyolefin, polyamide, polyethers, fluoropolymer, polyvinyl fluoride, polyvinylidene fluoride, polychlorotrifluoroethylene, polyvinyl chloride, acrylic, or a combination comprising at least one of the foregoing.

11. The thermoplastic sheet of claim 1, wherein the thermoplastic substrate comprises polycarbonate, copolymers of polycarbonate, or a combination comprising at least one of the foregoing.

12. The thermoplastic sheet of claim 11, wherein the polycarbonate includes bisphenol-A polycarbonate, dimethyl bisphenol cyclohexane polycarbonate, or combinations comprising at least one of the foregoing.

13. The thermoplastic sheet of claim 1, wherein the masking film is applied to the surface of the thermoplastic substrate via spraying, painting, coating, laminating, or a combination comprising at least one of the foregoing.

14. The thermoplastic sheet of claim 1, wherein the masking film has a thickness of 10 micrometers to 100 micrometers on the surface of the thermoplastic substrate.

15. The thermoplastic sheet of claim 1, wherein the thermoplastic substrate has a thickness of 0.15 millimeter to 20 millimeters.

16. The thermoplastic sheet of claim 1, wherein the masking film is coated with a rubber based glue, an acrylic adhesive, or a combination comprising at least one of the foregoing.

17. The thermoplastic sheet of claim 1, wherein the article is a panel for use in an automobile, aircraft, or railway.

18. The thermoplastic sheet of claim 5, wherein the masking film can be removed from the surface of the article at room temperature via scraping, peeling, or a combination comprising at least one of the forgoing.

19. A method of thermoforming an article, comprising:
extruding a thermoplastic sheet;
applying a masking film to a surface of the thermoplastic sheet, wherein the masking film comprises a polyamide, a polyester, or a combination comprising at least one of the foregoing;
shaping the thermoplastic sheet to form the article, wherein the masking film remains in contact with the surface of the thermoplastic sheet during shaping; and
after cooling the article, removing the masking film from a surface of the article.

20. The method of claim 19, wherein the masking film is applied to the surface of the thermoplastic sheet at room temperature or wherein the masking film is applied to the surface of the thermoplastic sheet continuously during extrusion of the thermoplastic sheet.
